(19) United States
(12) Patent Application Publication
(10) Pub. No.: US 2013/0179832 A1
(43) Pub. Date: Jul. 11, 2013

(54) METHOD AND APPARATUS FOR DISPLAYING SUGGESTIONS TO A USER OF A SOFTWARE APPLICATION

(71) Applicants: Carlos Bhola, New York, NY (US); Gerald Kropitz, New York, NY (US); Brian Rogers, New York, NY (US); Ludovic Cabre, New York, NY (US); Kapil Goel, New York, NY (US)

(72) Inventors: Carlos Bhola, New York, NY (US); Gerald Kropitz, New York, NY (US); Brian Rogers, New York, NY (US); Ludovic Cabre, New York, NY (US); Kapil Goel, New York, NY (US)

(73) Assignee: Kikin Inc.

(21) Appl. No.: 13/348,532

(22) Filed: Jan. 11, 2012

(51) Int. Cl. G06F 3/048

(52) U.S. Cl. 715/808; 715/764

(57) ABSTRACT

A method for displaying information to a user of a software application includes the steps of: receiving from a user a non-navigational input event evidencing an intention to change what the browser displays; and displaying information to the user responsive to content already displayed by the software application. A corresponding apparatus is also disclosed.

### FIELD OF THE INVENTION

Embodiments of the present invention relate generally to the field of suggesting information to a user of a software application. In particular, the present invention relates to suggesting information, such as possible URLs, search terms, or alternate applications to a user of a software application such as web browsing applications, content-driven applications, such as media readers on mobile devices, or productivity applications like a PDF readers, document editing programs, spreadsheet programs, or email programs

### BACKGROUND OF THE INVENTION

The World Wide Web has become a daily resource for many people. However, the large and relatively unstructured nature of the Web makes it difficult to find sites that are useful or relevant. Similarly, there are now many applications available to users and each application often has many features, all of which can leave a user bewildered and in need of guidance.

### SUMMARY OF THE INVENTION

The systems and methods described herein display information, such as suggested URLs, suggested search terms, and suggested alternate applications, to a user in response to determining that a user intends to change the current display or the current activity. For example, a non-navigational input received from a user indicates that the user desires to change the content currently displayed by a web browsing application without actually causing the transition to occur.

In one aspect, the present invention relates to a method for displaying information to a user of a software application when the user evidences an intent to change the current activity. In one particular embodiment, a non-navigational user event is received from the user evidencing an intention to change what is displayed by a software application. Information responsive to the already-displayed content is displayed to user prior to receiving a second input event from the user.

In another aspect, the present invention relates to an apparatus for displaying information to a user of a software application. In one particular embodiment, the present invention relates to an apparatus for displaying information to user of a software application when the user evidences an intent to change what is displayed by the software application. The apparatus includes means for receiving from a user a non-navigational input event evidencing an intention to change what the display and means for displaying, prior to receiving from the user a second input event, information to the user responsive to content already displayed by the software application.

In still another aspect, the present invention relates to a method for determining information to present to a user. A rich abstract of content currently displayed by a software application is required, prominent entities in the page are identified, information related to the prominent entity is determined and transmitted from the server.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a schematic diagram of a system in accordance with an embodiment of the present invention;

FIG. 1B is a schematic diagram of an embodiment of a computing device useful in the system depicted in FIG. 1A;

FIG. 1C is a block diagram of another embodiment of a computing device useful in the system depicted by FIG. 1A;

FIG. 2 is a screen shot of a software application displaying information, in accordance with an embodiment of the present invention;

FIG. 3 is a flow diagram depicting one embodiment of the steps to be taken to present suggestion to a user of a software application;

FIG. 4 is a screenshot depicting an embodiment of displaying suggestion to a user of a software application;

FIG. 5A is a screenshot of an executing contact management application; and

FIG. 5B is a screenshot of an embodiment presenting suggestion information to a user of the application depicted in FIG. 5A.

### DETAILED DESCRIPTION OF THE INVENTION

Various embodiments of the present invention provide a process or system for suggesting information, such as URLs, search terms, or alternate applications, to a user. In particular ones of these embodiments, the information is suggested in response to determining that a non-navigational input received from the user indicates that the user desires to change the content currently being displayed by the software application.

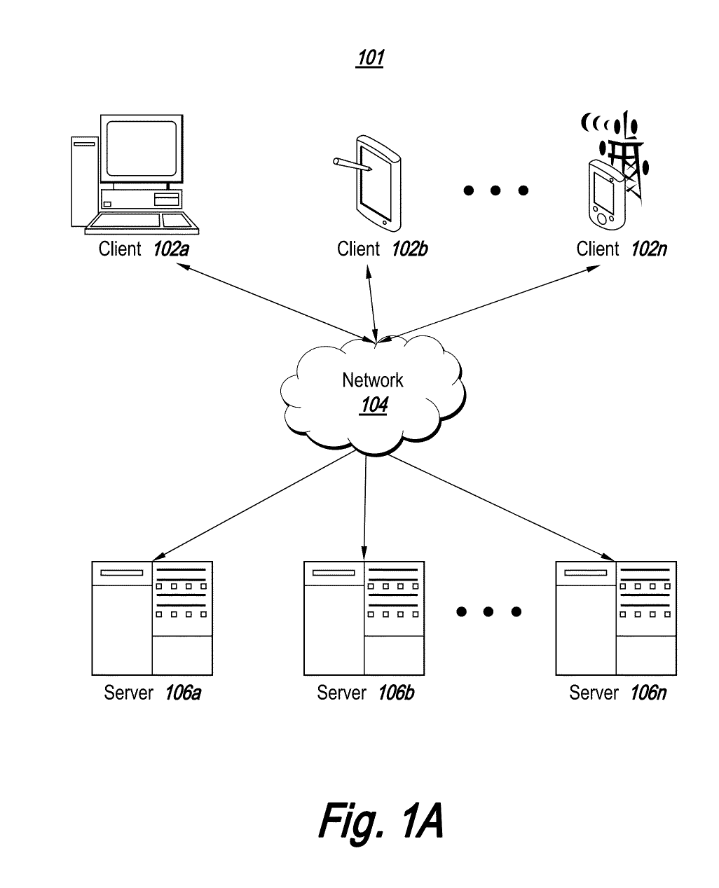

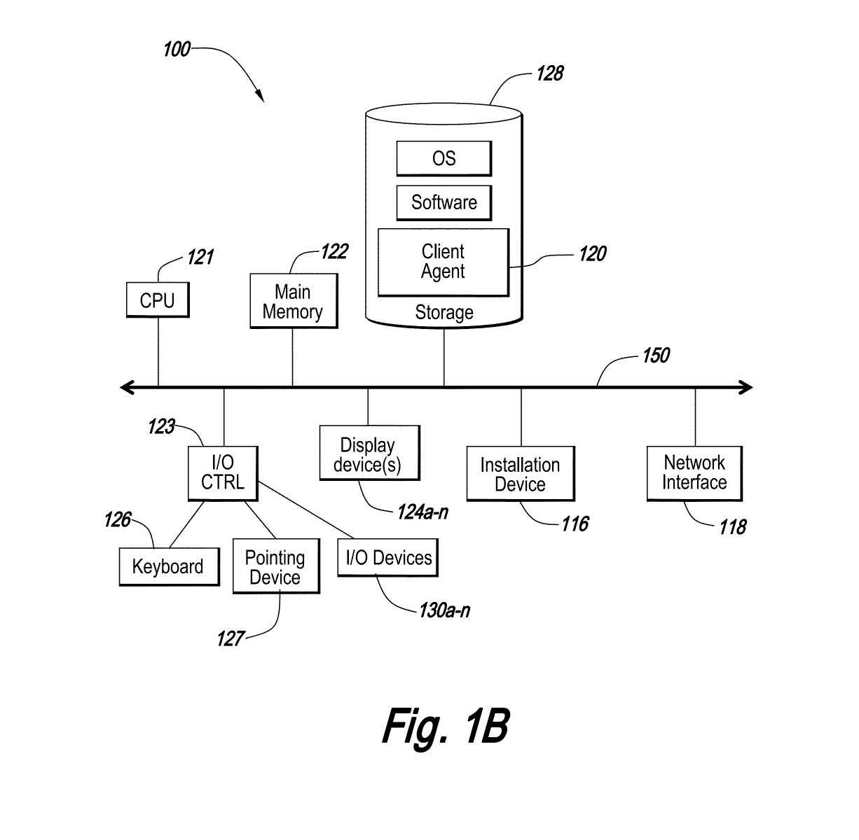

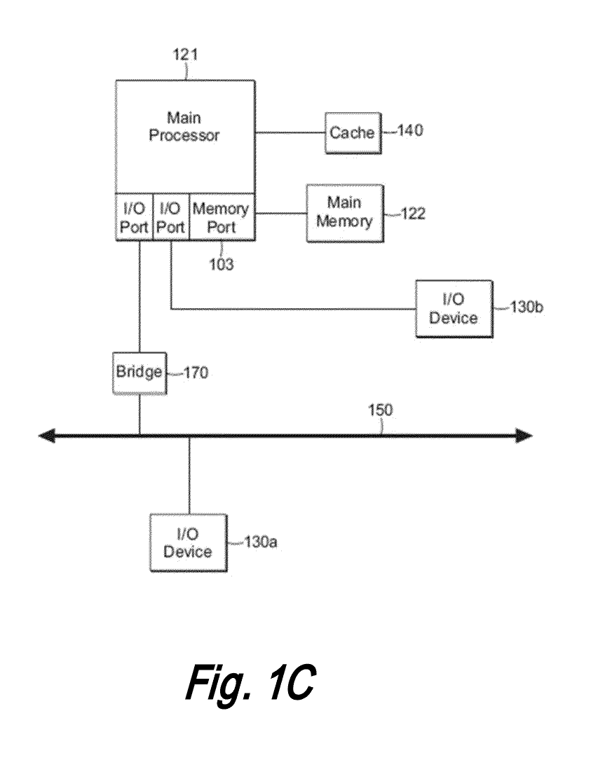

FIG. 1A illustrates one embodiment of a computing environment 101 that includes one or more client machines 102A-102N (generally referred to herein as “client machine(s) 102,” “client(s) 102,” “client computer(s) 102,” “client device(s) 102,” “client computing device(s) 102,” “local machine(s) 102,” “client node(s) 102,” “endpoint(s) 102,” “endpoint node(s) 102” or “second machine(s) 102”) that is in communication with one or more servers 106A-106N (generally referred to herein as “server(s) 106,” “remote machine(s) 106,” “server farm(s) 106,” “host computing device(s) 106,” or first machine(s) 106″). Installed in between the client machine(s) 102 and server(s) 106 is a network 104. In one embodiment, the computing environment 101 can include a network appliance (not shown) installed between the server(s) 106 and client machine(s) 102. Such a network appliance can mange client/server connections and in some cases can load balance client connections amongst a plurality of servers 106.

The client machine(s) 102 may be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

In one embodiment, the client machine 102 can be a virtual machine. The virtual machine can be any virtual machine managed by a hypervisor developed by XenSolutions, Citrix Systems, IBM, VMware, or any other Type 1 or Type 2 hypervisor. The virtual machine may be managed by a hypervisor executing on a server 106 or a hypervisor executing on a client 102.

The client machine 102 can in some embodiments execute, operate or otherwise provide an application that can be anyone of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The server 106, in some embodiments, executes a remote presentation server or other program that uses a thin-client or remote-display protocol to transmit display output generated by an application executing on a server 106 to a remote client 102. The thin-client or remote-display protocol can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

The computing environment 101 can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS NT, manufactured by Microsoft Corp. of Redmond, Wash., UNIX, LINUX, or Mac OS, manufactured by Apple Computer of Cupertino, Calif.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. In embodiments where the server 106 comprises an appliance, the server 106 can be an appliance manufactured by anyone of the following manufacturers: the Citrix Application Networking Group; Silver Peak Systems, Inc; Riverbed Technology, Inc.; F5 Networks, Inc.; or Juniper Networks, Inc. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

The server 106 can, in some embodiments, execute anyone of the following applications: a thin-client application using a thin-client protocol to transmit application display data to a client; a remote display presentation application; any portion of the CITRIX ACCESS SUITE by Citrix Systems, Inc. like XenApp or XenDesktop; MICROSOFT WINDOWS Terminal Services manufactured by the Microsoft Corporation; or an ICA client, developed by Citrix Systems, Inc. Another embodiment includes a server 106 that is an application server such as: an email server that provides email services such as MICROSOFT EXCHANGE manufactured by the Microsoft Corporation; a web or Internet server; a desktop sharing server; a collaboration server; or any other type of application server. Still other embodiments include a server 106 that executes anyone of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wire line network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be anyone of the following: AMPS; TDMA; CDMA; GSM; GPRS UMTS; or any other protocol able to transmit data among mobile devices.

Illustrated in FIG. 1B is a block diagram of an embodiment of a computing device 100 suitable for use as the client machine 102 or server 106 illustrated in FIG. 1A. Included within the depicted computing device 100 is a system bus 150 that communicates with the following components: a central processing unit 121; a main memory 122; storage memory 128; an input/output (I/O) controller 123; display devices 124a-124n; an installation device 116; and a network interface 118. In one embodiment, the storage memory 128 includes: an operating system, software routines, and a client agent 120. The I/O controller 123, in some embodiments, is further connected to a keyboard 126, and a pointing device 127. Other embodiments may include an I/O controller 123 connected to more than one input/output device 130a-130n.

FIG. 1C illustrates another embodiment of a computing device 100 suitable for use as the client machine 102 or server 106 illustrated in FIG. 1A. Included within the depicted computing device 100 is a system bus 150 that communicates with the following components: a bridge 170, and a first I/O device 130a. In another embodiment, the bridge 170 is in further communication with the main central processing unit 121, where the central processing unit 121 can further communicate with a second I/O device 130b, a main memory 122, and a cache memory 140. Included within the central processing unit 121, are I/O ports, a memory port 103, and a main processor.

Embodiments of the computing machine 100 can include a central processing unit 121 characterized by anyone of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; those manufactured by International Business Machines; those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121, may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (not shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130a-130n. In some embodiments, the local system bus 150 can be anyone of the following types of buses: a VESA VL bus; an ISA bus; an EISA bus; a MicroChannel Architecture (MCA) bus; a PCI bus; a PCI-X bus; a PCIExpress bus; or a NuBus. Other embodiments of the computing machine 100 include an I/O device 130n that is a video display 124 that communicates with the central processing unit 121. Still other versions of the computing machine 100 include a processor 121 connected to an I/O device 130n via anyone of the following connections: HyperTransport, Rapid I/O, or InfiniBand. Further embodiments of the computing machine 100 include a processor 121 that communicates with one I/O device 130d using a local interconnect bus and a second I/O device 130b using a direct connection.

The computing device 100, in some embodiments, includes a main memory unit 122 and cache memory 140. The cache memory 140 can be any memory type, and in some embodiments can be anyone of the following types of memory: SRAM; BSRAM; or EDRAM. Other embodiments include cache memory 140 and a main memory unit 122 that can be anyone of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for anyone of the following installation devices 116: a CD-ROM drive, a CD-Rare drive, a DVD-ROM drive, tape drives of various formats, USB device, a bootable medium, a bootable CD, a bootable CD for GNU/Linux distribution such as KOPI®, a hard-drive or any other device suitable for installing applications or software. Applications can in some embodiments include a client agent 120, or any portion of a client agent 120. The computing device 100 may further include a storage device 128 that can be either one or more hard disk drives, one or more solid-state drives or compact flash cards or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FADDY), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100 via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise anyone of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include anyone of the following I/O devices 130a-130n: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103a-130n to control the one or more I/O devices. Some embodiments of the I/O devices 130a-130n may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can connect to multiple display devices 124a-124n, in other embodiments the computing device 100 can connect to a single display device 124, while in still other embodiments the computing device 100 connects to display devices 124a-124n that are the same type or form of display, or to display devices that are different types or forms. Embodiments of the display devices 124a-124n can be supported and enabled by the following: one or multiple I/O devices 130a-130n; the I/O controller 123; a combination of I/O device(s) 130a-130n and the I/O controller 123; any combination of hardware and software able to support a display device 124a-124n; any type and/or form of video adapter, video card, driver, and/or library to interface, communicate, connect or otherwise use the display devices 124a-124n. The computing device 100 may in some embodiments be configured to use one or multiple display devices 124a-124n, these configurations include: having multiple connectors to interface to multiple display devices 124a-124n; having multiple video adapters, with each video adapter connected to one or more of the display devices 124a-124n; having an operating system configured to support multiple displays 124a-124n; using circuits and software included within the computing device 100 to connect to and use multiple display devices 124a-124n; and executing software on the main computing device 100 and multiple secondary computing devices to enable the main computing device 100 to use a secondary computing device's display as a display device 124a-124n for the main computing device 100. Still other embodiments of the computing device 100 may include multiple display devices 124a-124n provided by multiple secondary computing devices and connected to the main computing device 100 via a network.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS 7 and WINDOWS VISTA; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS, manufactured by Parallels Holdings, Ltd., or another virtualization platform that can execute or manage a virtual machine executing a first operating system, while the computing machine 100 executes a second operating system different from the first operating system.

The computing machine 100 can be embodied in anyone of the following computing devices: a computing workstation; a desktop computer; a laptop or notebook computer; a server; a handheld computer; a mobile telephone; a portable telecommunication device; a media playing device; a gaming system; a mobile computing device; a netbook; a tablet computing device, such as the IPAD family of devices manufactured by Apple Computer, a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as anyone of the following mobile devices: a JAVA-enabled cellular telephone or personal digital assistant (PDA), such as the i55sr, i58sr, i85s, i88s, i90c, i95c, or the i100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be anyone of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device.

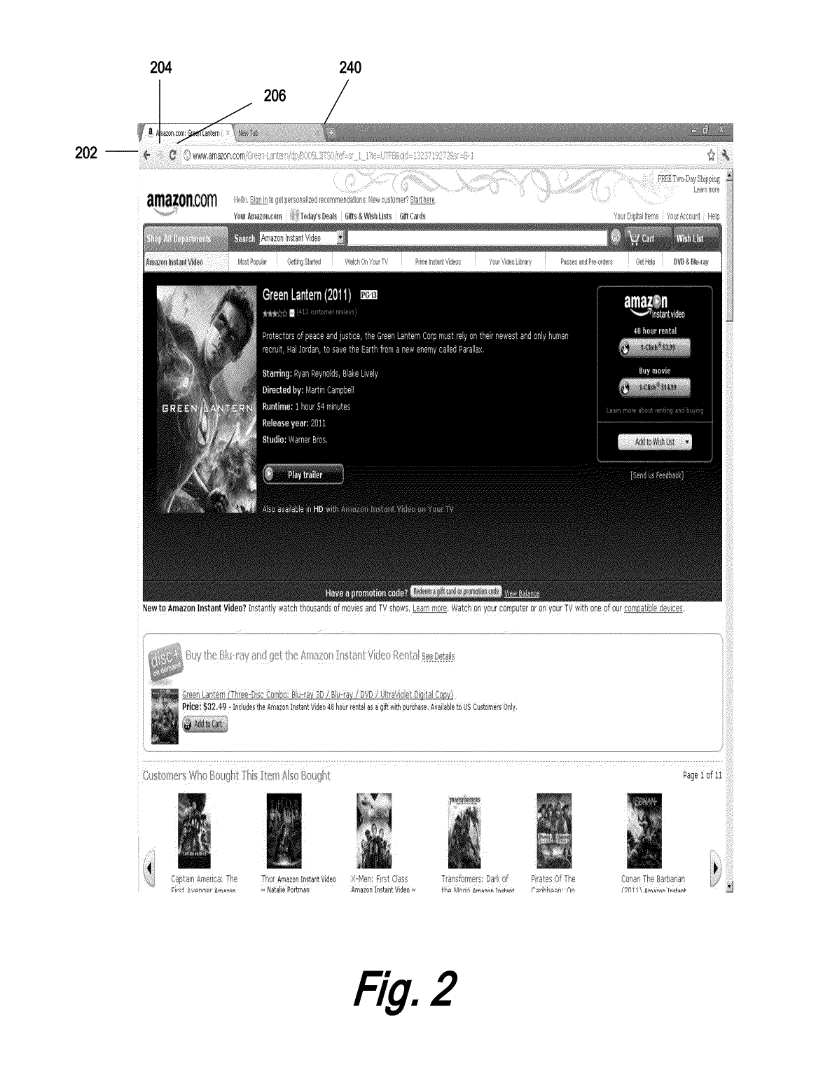

Referring now to FIG. 2, an embodiment of a software application displaying a page of information is depicted. As shown in the embodiment depicted by FIG. 2, there are several ways in which a user can provide input to evidence an intent to change what the software application displays or that the user intends to change activities. Certain input mechanisms are referred to by this document as “navigational inputs.” For example, as shown in FIG. 2, a user may click or touch the back arrow 202 or the forward arrow 204, which causes the browser application to display the immediately-previous page in the browser's history or the next page in the browser's history, respectively. Similarly, clicking the refresh icon 206 is also an example of a navigational input, as that input causes the software application to refresh the page of content currently displayed without requiring additional input from the user. Another example of a navigational input is clicking on a scroll bar provided by an application or using a touch gesture to scroll displayed content.

Other inputs are referred to by this description as “non-navigational inputs,” that is, the main purpose of the input is not to immediately transition the software application from a currently-displayed page of content to a new (or old) page of content. For embodiments in which the software application is a web browsing application, such as that shown in FIG. 2, activating the address bar 220 by clicking in it, or touching in it for embodiments in which the computing device 100 supports a touch screen, is an example of a non-navigational input. Similarly, clicking or touching a control that requests the creation of a new tab (shown in FIG. 2 as 260) is another example of a “non-navigational input.” Other examples include touching or clicking in a search bar, when provided, or touching or clicking a bookmark icon to retrieve a list of previously-bookmarked pages. Another example of non-navigational inputs include right-clicking, or touching and holding, a term displayed by the software application; such activity may indicate the user desires to look up the meaning of the term. Similarly, selection of a menu item provided by the software application may indicate the user desires to change activity. Alternatively, the described systems and methods may determine that the user intends to change activity when the user starts hovering over a minimized application taskbar widget or dock icon,

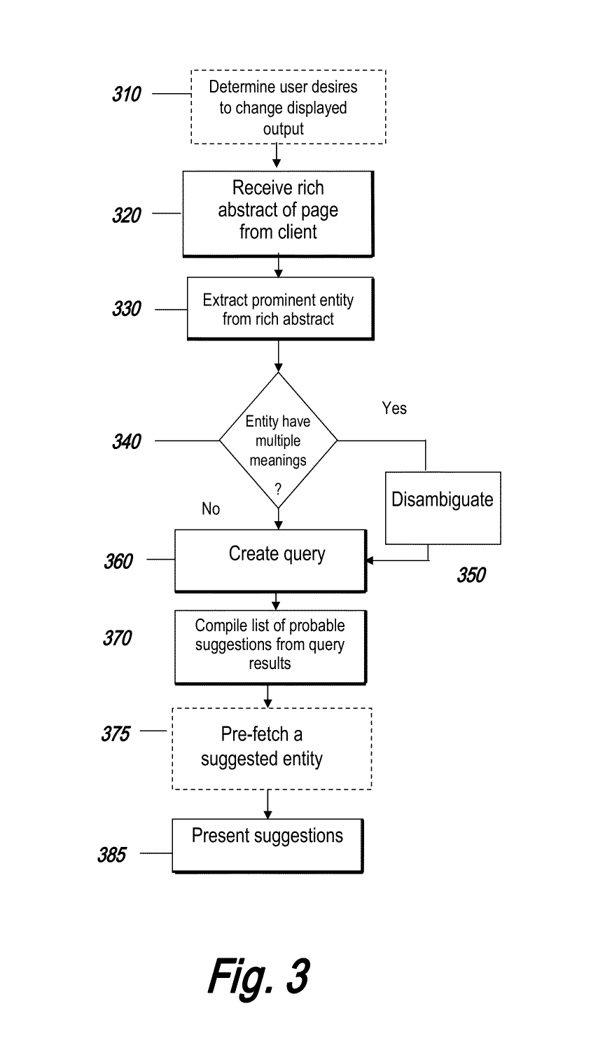

Referring now to FIG. 3, one embodiment of the steps taken to suggest information to a user of the software application is shown. In brief overview, the steps depicted in FIG. 3 may begin when the system determines that a user desires to change the content currently displayed by the software application or to change the current activity (step 310, shown in phantom view). A rich abstract of the currently-displayed page of content is compiled and received by the server (step 320). One or more entities that feature prominently in the rich abstract are extracted (step 330) and a determination is made regarding whether any of the extracted entities have multiple meanings (step 340). If one or more of the extracted entities has multiple meanings, those entities are disambiguated (step 350). After disambiguation, or of it was determined in step 340 that an entity is not ambiguous, a query is created using the entities (step 360). A list or probable suggestions is created from the results returned by the created query (step 370) and the list of probable suggestions is presented to the user (step 380). As shown in FIG. 3, an optional step may be taken between compiling the list of probable suggestions and presenting those to the user; if a web page is identified by one of the probable suggestions, it may be pre-fetched (step 375, shown in phantom view).

Still referring to FIG. 3, and in greater detail, the depicted process may begin when the system determines that a user desires to change the content currently displayed by the software application (step 310, shown in phantom view). A first, non-navigational user input event is captured. In some embodiments, the non-navigational user input event that is captured is a click or touch to activate the address bar, a click or touch to activate a search box, when provided, a double-press on a home hey, such as those provided by IOS-based devices, a long press on a home key for ANDROID-based devices, or a click or touch to activate a bookmark icon. If the system determines that the captured non-navigational user input event evidences a desire to change the content currently displayed, a rich abstract of the page is compiled and transmitted to the server. In one particular embodiment, user input events are captured by the following Objective-C code:

UITouch* touch = [touches anyObject];

if (CGRectContainsPoint(self.bounds, [touch locationInView:self])) {

//Begin Fig. 3 at step 320

},

In many embodiments, the rich abstract that is compiled and sent to the server includes content currently displayed by the software application. For example, the HTML code comprising a page displayed by a browser application can be sent as the rich abstract. In other embodiments, the text of a document currently being viewed or edited may be sent as the rich abstract. In still other embodiments, the contact information from an address management application may be sent as the rich abstract.

In still other embodiments, the rich abstract may be augmented by metadata associated with the user or from the displayed content. According to various embodiments, information related the user's profile may be included in the rich abstract sent to the server. Such information includes, but is not limited to, any combination of the user's history of documents visited, favorite websites or bookmarks, categories of favorite websites or bookmarks, shares, prior searches, recent prior searches, the search that referred the user to the current webpage, saves, interests, social networks, frequently accessed applications/documents/websites, a Bloom filter data structure that represents all domains that the user visited during a specific period of time, a Bloom filter data structure that represents all domains from which the user saved a webpage, a Bloom filter data structure that represents all domains on which the user shared a webpage, or the like.

Searches performed by the user may be stored and used as part of the user profile. Additionally, as the user visits web pages, the URLs of those web pages may be recorded and, in some embodiments, sent to the server. For example, if a user searches www.google.com for “new camera” and then visits multiple web pages about cameras, that search and the pages visited by the user will be included in the rich abstract and used by the server to refine the context associated with the rich abstract.

Similarly, the bookmarks saved by a user during web browsing may be accessed and sent to the server as part of a rich abstract. For example, if a user has bookmarked google.com, bbc.com/news, and cnn.com, the server may use this fact to provide more news-related sites in response to captured user input.

According to some exemplary embodiments, the rich abstract may include information relating to META tags embedded in the content or information regarding word frequencies of the text in the document. Word frequencies may be calculated on the client and included in the HTTP POST request to the server.

In some embodiments, the DOM tree for a page of displayed content may be included in the rich abstract. In other embodiments, the client device 102 may traverse the DOM tree to identify specific nodes and include in the rich abstract only those nodes that are identified.

In further embodiments, information about the application currently executing may be exposed by an API provided by the operating system of the client 102 and included in the rich abstract. In some particular embodiments, the system is able to access the title of the window, or window name, as well as the name of the currently-executing application. Certain applications may allow access to further information. For example, an email program may also allow access to the title of the email, that is, the “subject” line and a word processing program may allow access to the title of the displayed document or to other characteristics of the document, such as word count. When available, this information may also be included the rich abstract that is sent to the server 106. According to various embodiments, the rich abstract may be sent as string that is URL encoded so that it can be included in the body of a HTTP POST request. The rich abstract can include both the page entities and context information.

The server 106 receives the rich abstract from the client 102 (step 320). In some latency-sensitive embodiments, the process steps beginning at step 320 may be executed prior to capture of a non-navigational user input event; for example, the steps may be processed substantially immediately upon download of content to display using the software application. In other embodiments, processing begins at step 320 only after a non-navigational user input event is captured at step 310.

According to some embodiments, the page is scanned in its entirety to identify terms that potentially represent entities and entities are determined, at least in part, through a disambiguation process using a processor of a computing device. The disambiguation process itself also involves determining the local context in order to determine the boundaries of each identified entity (or entities). For example, according to a non-limiting, exemplary embodiment and referring briefly back to FIG. 2, the system identifies as input “Starring: Ryan Reynolds, Blake Lively.” The service then determines that, for instance, “Ryan Reynolds” is a term that is searched for more often than “Reynolds, Lively”. The system also determines that “Ryan Reynolds” is a more desirable search term than “Ryan”. Therefore, the systems selects “Ryan Reynolds” as an entity to include in the rich abstract of the page depicted in FIG. 2.

The server identifies one or more entities that feature prominently in the rich abstract (step 330). In some embodiments, the server uses local context to find prominent term(s), collections of term(s), or the like. According to some embodiments, such terms include (but are not limited to): postal addresses, email addresses, URLs (which may or may not correspond with a hypertext link), currency, phone numbers, geographic locations, or the like. In these embodiments, regular expressions may be used to determine the existence of these types of terms. Exemplary regular expressions include: address—[{regex:/[\t\r\n]*(.+[,\u00A0]{1,}[A-Z]{2}[\u00A0]?[\d][5})($|[\-\r\n]+)/}, {regex:/(\d+\w*[̂\r\n,]+(?:Street|St|Avenue|Ave)(,\d+\w+Floor)?)/}]; currency—{code: ‘USD’, symbol: ‘$’, name: ‘dollars?’}, {code: ‘EUR’, symbol: [symbol] , name: ‘euros?’}, {code: ‘GBP’, symbol: £, name: ‘pounds?’}; Twitter handle—/̂@[A-Za-z0-9_]+$/; and phone—[{regex:/([\d]{2}[\d]{2}[\d]{2})/}, {regex:/([\d]{4}[\d]{4})}regex:/((\+[\d+)?\(?[\d]{3}\)?[−][\d]{3}[−][\d]{4})/}].

According to some embodiments, entities may be chosen based on whether the terms begin with a capital letter, are in all capital letters, or are in mixed case. According to some embodiments, such terms may be chosen from the beginning or end of a nearby sentence, where some embodiments take care to ignore periods that do not denote the end of a sentence (such as those used for abbreviations such as “U.S.” or “Inc.”). Some embodiments choose such terms based on the existence or non-existence of a nearby word “bridges” such as (but not limited to) the “of” in “the United States of America”, apostrophes used to indicate possession (“Gerry's”), ampersands (“His & Hers”), and the like. In many embodiments this behavior is provided via a rule base containing commonly-used rules.

Some embodiments ignore terms that are common (for example, ignoring “more”). Some embodiments choose terms based on whether the surrounding HTML tag or other encoding denotes it with a special tag (for example, bold, italic, links, heading tags (<h1>, <h2>, <h3>), or the like). Some embodiments choose terms based on whether the parent node in a HTML or similar document is marked as a Microformat or special semantic tag. Some embodiments choose terms based on a Microformat where the Microformat consists of multiple parts (like an address), scan surrounding areas for the other related tags to highlight them at the same time. Some embodiments choose terms based on detected sentences, dictionary terms, nouns, or the like. Various embodiments choose terms based on any combination of the examples described above, or other similar examples.

In still further embodiments, every type of analysis described above is performed in order to identify entities extant on a displayed page. In still other embodiments, various subsets of the identified techniques may be applied. For embodiments in which the display of the client machine 102 is smaller than the content to be displayed, such as is often the case with a tablet computing device or mobile phone, the server 106 may analyze only the area of the content displayed by the client machine 102, when that information is included in the rich abstract received from the client machine 102. For example, the following JavaScript may be used to determine if the device is a mobile device: navigator.userAgent.indexOf(‘mobile’). The rules and techniques may be applied independently of structural boundaries in the displayed page; for example, processing is not affected by text wrapping from one line to the next.

The server may identify entities present in a rich abstract based on a most probable sequence of words present in the abstract. In one embodiment, the server accomplishes this by generating a list of n-word-grams. In some embodiments, the number words used to create the word grams are 10 words, in other embodiments 8 words are used, in still other embodiments 6 words are used, in still further embodiments 4 words are used and in still other embodiments 2 words are used. The length of the n-gram is used to create a sliding window which creates sets of overlapping n-word-grams to be processed.

As an example of this, for the sentence:
Tunisia, the country where the Arab Spring uprisings began this year, has joined the International Criminal court, becoming the first North African country to do so

in an embodiment in which 6 words are used and the sliding window begins at “this,” the initial set of word grams prepared would be:

this year has joined the international
year has joined the international criminal
has joined the international criminal court
joined the international criminal court becoming
the international criminal court becoming the
international criminal court becoming the first
criminal court becoming the first north
year has joined the international
has joined the international criminal
joined the international criminal court
the international criminal court becoming
international criminal court becoming the
criminal court becoming the first
has joined the international
joined the international criminal
the international criminal court
international criminal court becoming
criminal court becoming the
joined the international
the international criminal
international criminal court
criminal court becoming
the international
international criminal
criminal court
international
criminal

In some embodiments, each of the generated word-grams may be used as input to a search engine, such as google.com, bing.com, yahoo.com and the like. The results returned from these searches can be reviewed to determine if any of the results contain links to a knowledge management site, such as wikipedia.com. Word-grams that returned search results having links to a knowledge management site are then ordered from most popular to least popular. The longest word-gram returning the most popular search is selected as most prominent entity in the For embodiments in which an image is included in the rich abstract, the image may be submitted to a facial recognition service to identify the pictured person or product. The result from that conversion, which is text, may be identified as an entity extant in the abstract or may then be used in the word-gram processing described above. For embodiments in which an audio file is included in the rich abstract, a digital fingerprint of the audio may be submitted to an audio recognition service, such as services offered by Rovi Shazam and IntoNow. In some embodiments, the audio fingerprint that is submitted to the audio recognition service is generated by executing a hash on the PCM data comprising the file. The result returned from the audio recognition service, which is text, is then used as the selected entity to search.

For embodiments in which a DOM tree is provided as part of the rich abstract, contextual information may be obtained about identified entities by traversing the DOM tree to ascertain the node previous to the node containing an entity and extracting the content of the previous node and also to ascertain the node following the node containing an entity and extracting the content of the next node. Thus, in the following sentence: “Nicolas Sarkozy is the 23^{rd} President of the French Republic,” in which “23^{rd} President” is the term being processed, the text “Nicolas Sarkozy” will be identified as contextual information relating to the term “23^{rd} President.” A similar technique may be used to identify text after an entity being processed, i.e., in the sentence above the term “French Republic” may also be identified as contextual information relating to the term “23^{rd} President.” Exemplary code for extracting the content from the previous node is as follows:

getPreviousTextNode: function(node) {

var childs = node.parentNode.childNodes,
idx = −1;
for (var i=0; i<childs.length; i++) {

if (childs[i] === node) {

idx = i;
break;

}

}
if (idx > 0) {

var pnode = childs[idx−1];
while (pnode.childNodes.length > 0) {

pnode = pnode.childNodes[pnode.childNodes.length−1];

}
return pnode;

} else {

return this.getPreviousTextNode(node.parentNode);

}

}

Similarly, exemplary code for obtaining the content of the next node is as follows:

getNextTextNode: function(node) {

if (!node || !node.parentNode) return null;
var childs = node.parentNode.childNodes,
idx = −1;
for (var i=0; i<childs.length; i++) {

if (childs[i] === node) {

idx = i;
break;

}

}
if (idx < childs.length−1) {

var pnode = childs[idx+1];
while (pnode.childNodes.length > 0) {

pnode = pnode.childNodes[0];

}
return pnode;

} else {

return this.getNextTextNode(node.parentNode);

}

}

In still other embodiments, the system may acquire text associated with headers from the displayed page using the JavaScript command “document.querySelectorAll(‘h1,h2,h3,h4,h5,h6,h7,h8’). The acquired text is then included in the rich abstract sent to the server. The system may also search the DOM of the displayed page to identify META tags. The text associated with META tags may also be useful. Each of the META tags in a document will be returned by the following command: document.getElementsByTagName(‘meta’) and each returned tag may be analyzed using the following exemplary code:

for(i = 0; i < metas.length; i++) {

if(metas[i].name == ‘keywords’){

richAbstract[‘keywords’] = metas[i].content;

}

}

In another embodiment, information about the HTML hierarchy of the displayed page may be used to determine context. In the example above, the HTML code for displaying the address to the user may be:

<div id=’address’>

Our address:
<address>

132 crosby street, New York, NY 10012

</address>

</div>

In these embodiments processing “New York” will cause the system to traverse the DOM model for the page and detect that the processed entity is part of an ADDRESS tag and a DIV tag. The extracted hierarchal information is included in the rich abstract request sent to the server.

In still other embodiments, the system may identify entities using microformats, when available. Microformats are attributes of HTML elements that store extra information, not visible to the user, about a tag. For example:

<p itemprop=“address” itemscope=“” itemtype=“http://data-
vocabulary.org/Address”>

<span itemprop=“stress-address”>2 Lincoln Place</span>,

<span itemprop=“locality”>

Brooklyn

</span>
<span itemprop=“region”>

NY

</span>

</span>

</p>

In the example above, if the term “Brooklyn” is being processed, the system will detect the presence of the property “itemprop” and parse the DOM tree to tag the selection as an address. If a microformat is identified, it is saved and included in the rich abstract sent to the server.

According to various embodiments, after the rich abstract is constructed it is sent, using a processor, to the server(s) 106. According to various embodiments, the processor sends the rich abstract (or abstracts) to the server(s) 106 using a networking device. According to some embodiments, the rich abstract is not sent to a server and is instead processed on the client 102. Alternatively, the rich abstract may be both sent to the server(s) 106 and processed locally. According to further embodiments, no rich abstract is constructed and, instead, the contextual information that would have otherwise been used for a rich abstract is sent to the server(s) 106, processed locally, or both.

A determination is made regarding whether any of the extracted entities have multiple meanings (step 340). In some embodiments, the server 106 looks up each extracted entity in an ambiguous phrases directory to determine is an extracted term is ambiguous. In some of these embodiments, the ambiguous phrases directory is pre-constructed using Wikipedia (www.wikipedia.com) or a similar knowledge database. For example, if the term “apple” has been extracted from a rich abstract, the server accesses
http://en.wikipedia.org/wiki/Apple_(disambiguation)
   to determine that the term “apple” has multiple meanings

If one or more of the extracted entities has multiple meanings, those entities are disambiguated (step 350). In some embodiments, this is accomplished by the server comparing the text of the displayed content with the text of each Wikipedia page linked from the disambiguation page and, based on that textual analysis, use the page topic with the most significant overlap. Using the example above, the server 106 would compare the text of the displayed content that includes the entity “apple” with each page linked from the apple disambiguation page above. If, in this example, the page regarding “Apple Bank” includes more terms that overlap with the page of displayed content than any other disambiguation page, the term “Apple Bank” is selected as the term to use.

After disambiguation, or if it was determined in step 340 that an entity is not ambiguous, a query is created using the entities (step 360). In some embodiments, the server, using a processor, creates a query (or queries) to submit to a general search index using the identified terms. According to various embodiments, a standard query additionally includes context information related to the processed entity. According to some embodiments, if the server disambiguated the meaning of any ambiguous terms with the help of the contextual information, additional terms may be included in the query, as determined by the disambiguation process. According to some embodiments, Boolean logic is applied to standard query construction. In a non-limiting embodiment, for example, Boolean logic is used in constructing a standard query for an Internet Search source that accepts Boolean search queries.

According to some embodiments, unnecessary words in the entity are not included in the standard query. For example, if the entity is long, the entity may be shortened for the standard query, to increase the diversity of results. This is because search strings that are too specific may return results from too narrow a list of sources.

For each result returned by the general search, the server determines if there exists a direct relationship with the entity. A direct relationship translates into a user suggestion on 1-to-1 basis. If, instead, the returned search results focus on a specific facet of the entity, such as price, quality review, or reference information), the suggestions made to the user will be customized based on the user history and behavioral contextual information described above.

For example, “Pirates of the Caribbean: On Stranger Tides” general search results are:
1. disney.go.com/pirates/
2. www.imdb.com/title/tt1298650/
3. www.google.com/products
4. en.wikipedia.org/wiki/Pirates_of_the_Caribbean
5. www.youtube.com/watch?v=cUEjc
6. www.rottentomatoes.com/pirates_of_the_caribbean
7. movies.yahoo.com/movie/1809791042/info
8. trailers.apple.com/trailers/disney/
9. www.fandango.com/piratesofthecaribbean

The server looks up each link in a URL prefix to category map to determine if there is a direct or facet relationship to the entity. As example, “disney.go.com/pirates,” which represents the official homepage, does not show up in the category map, therefore it has direct relationship to the entity and will itself be a suggestion made to the user. Alternatively, www.imdb.com/title is mapped as “Reference>Movie,” therefore it is tagged as a facet relationship. Rather then representing a direct suggestion, this result will be customized based on user preferences and the user's current behavioral vector. For example, if the user prefers movie reviews from the New York Times, the server will suggest a link to the review of Pirates of the Caribbean from the New York Times, rather than the imdb link. Similarly, if the recent site vector of the user shows visits to websites that fall into the “Shopping” category, when the server encounters “www.google.com/product” link in search results (which is also mapped to “Shopping”), instead of identifying a single “Shopping” suggestion, the server will identify two suggestions from the user's favorite shopping destinations, e.g., amazon.com and ebay.com.

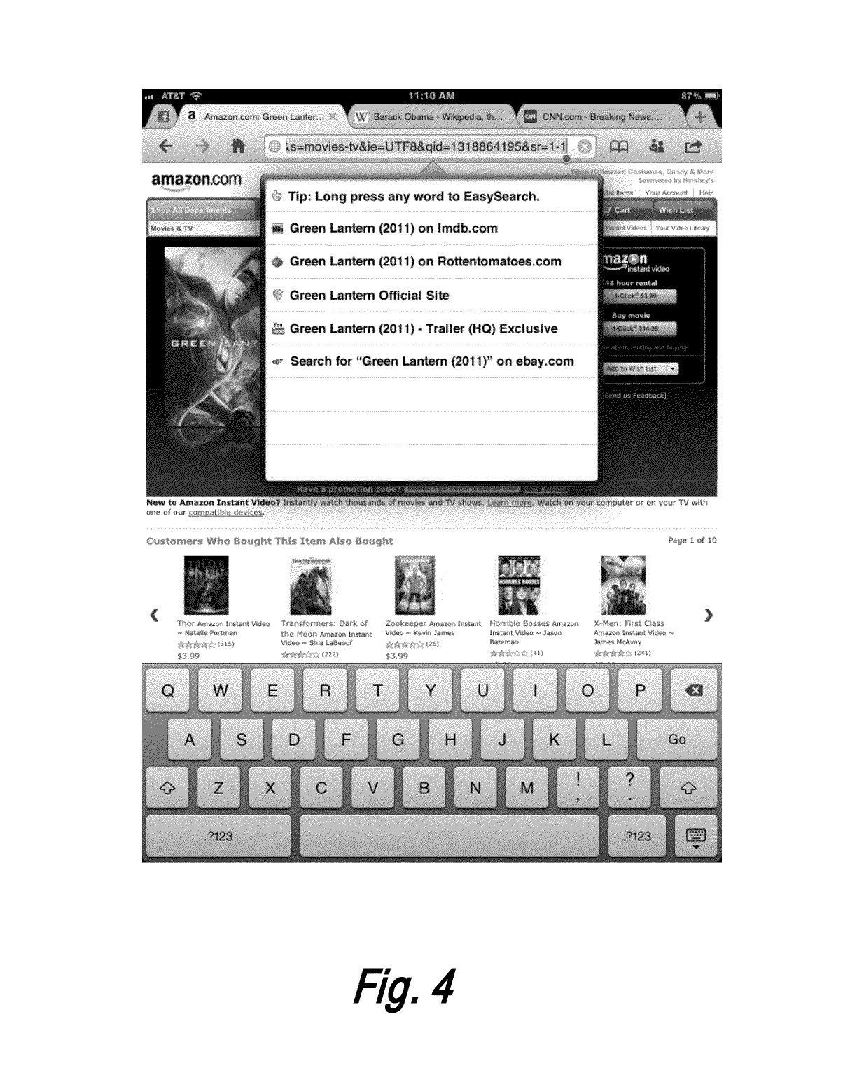

A list or probable suggestions is created from the results returned by the created query (step 370) and the list of probable suggestions is presented to the user (step 380). In some embodiments the set of suggestions is sent to the client as a JSON-encoded structure for display to the user. FIG. 4 is a screen shot depicting one embodiment of how the results might be displayed to user in response to capture of a non-navigational user input event. Although shown as a pop-up window in the embodiment depicted in FIG. 4, any container of information can be used to display the suggestions to the user. In some embodiments the suggestions are displayed to a user via a separate window or layer. In still other embodiments the suggestions are presented to the user inline with the displayed content.

As shown in FIG. 3, an optional step may be taken between compiling the list of probable suggestions and presenting those to the user; if a web page is identified by one of the probable suggestions, it may be pre-fetched (step 375, shown in phantom view). In some of these embodiments when multiple suggestions are identified, multiple items may be pre-fetched.

The systems and methods described above may be used in the context of an email processing program to suggest to user web pages regarding a specific company when the user selects the search box while viewing an email from a contact at that company.

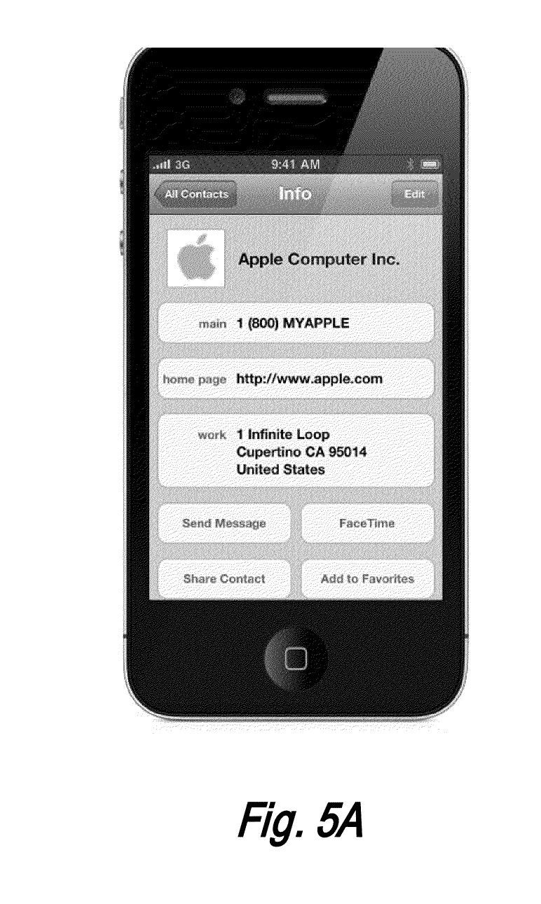

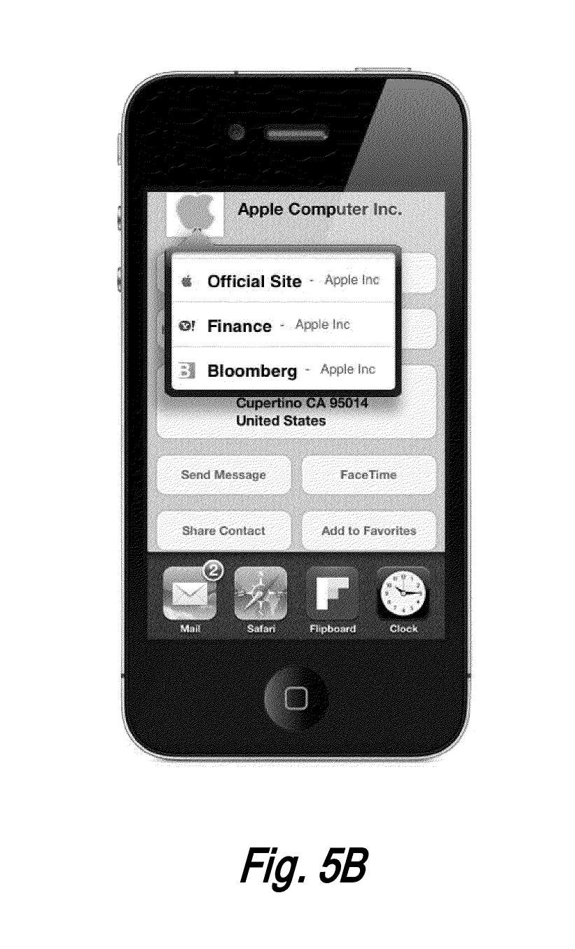

The systems and methods described above may be used in the context of an contacts management program on a mobile device to suggest to the user links to a social media profile for a person whose contact information is displayed when the mobile device's home button is double-pressed or long-pressed. Referring now to FIG. 5A, depicted is a screen shot of a contact management program executing on an iPhone device. As is well-known with iPhone devices, double-clicking the home button located at the bottom of the device signals that the user intends to switch to a different application. FIG. 5B depicts the result of that action when the described systems and methods are used. A pop up window is displayed listing three suggested destinations for the user of the device. Alternatively, the systems and methods described above could instead provide a link to an online map of, or site providing directions to, the address of the displayed contact.

The systems and methods described above may be used in the context of a productivity application to suggest to user help topics related to an action the user is attempting to perform when the user selects the help menu or help box

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, Objective C, PROLOG, or in any byte code language such as JAVA. The software programs may be stored on or in one or more articles of manufacture as object code.

While certain exemplary embodiments have been described and shown in the accompanying drawings, it is to be understood that such embodiments are merely illustrative of and not restrictive on the methods and systems described herein.

What is claimed:

1. A method for displaying information to a user of a software application, the method comprising:
receiving, from a user, a non-navigational input event evidencing an intention to change what the software application displays; and
displaying, prior to receiving from the user a second input event, a suggestion to the user responsive to content already displayed by the software application.

2. The method of claim 1 further comprising the step of creating, in response to receiving the non-navigational input event from the user, a rich abstract of the displayed content.

3. The method of claim 1 wherein receiving a non-navigational input event from a user comprises receiving, from a user, one of a mouse click in the address bar of the software application, a touch event in the address bar of the software application, a double-click of a home button provided by a device, a mouse hovering over a minimized desk icon, search bar, or a touch event in a search bar.

4. The method of claim 1 wherein displaying the suggestion to the user comprises displaying to the user or via a pop-up window or layer.

5. The method of claim 1 further comprising determining a suggestion to display to the user using an entity associated with displayed content.

6. The method of claim 5 wherein determining occurs prior to receiving a second input event from the user.

7. An apparatus for displaying information to a user of a software application, the apparatus comprising:
means for receiving, from a user, a non-navigational input event evidencing an intention to change what the browser displays; and
means for displaying, prior to receiving from the user a second input event, information to the user responsive to content already displayed by the software application.

8. The apparatus of claim 7 further comprising means for creating, in response to receiving the non-navigational input event from the user, a rich abstract of the displayed content.

9. The apparatus of claim 7 wherein said means for receiving a non-navigational input event from a user comprises means for receiving, from a user, one of a mouse click in the address bar of the software application, a touch event in the address bar of the software application, a double-click of a home button provided by a device, a mouse click on a minimized desk icon, search bar, or a touch event in a search bar.

10. The apparatus of claim 7 wherein said means for displaying the suggestion to the user comprises means for displaying to the user or via one of a pop-up window a layer.

11. The apparatus of claim 7 further comprising means for determining a suggestion to display to the user using an entity associated with displayed content.

12. The apparatus of claim 11 further comprising said means for determining operates prior to receipt of a second input event from the user by the means for receiving.

13. A method for determining a suggestion to present to a user of a software application, the method comprising:
receiving a rich abstract of content displayed to a user by a software application;
identifying a prominent entity contained in the received rich abstract;
determining a suggestion based on the identified prominent entity; and
transmitting the determined suggestion.

14. The method of claim 13, wherein identifying the prominent entity includes determining the local context to determine the boundary of the entity.

15. The method of claim 13, wherein identifying the prominent entity includes determining that the frequency with which a combination of words is searched exceeds a pre-determined threshold.

16. The method of claim 13, wherein identifying the prominent entity includes determining that a frequency with which a first word and a second word are searched exceeds a frequency with which the second word and a third word are searched.

17. The method of claim 13, wherein identifying the prominent entity includes determining evaluating capitalization of words in the page.

18. The method of claim 13, wherein identifying the prominent entity includes determining the existence of an HTML tag in the page.

19. An apparatus for determining a suggestion to present to a user of a software application, the apparatus comprising:
means for receiving a rich abstract of content displayed to a user by a software application;
means for identifying a prominent entity contained in the received rich abstract;
means for determining a suggestion based on the identified prominent entity; and
means for transmitting the determined suggestion.

20. The apparatus of claim 19, wherein the means for identifying a prominent entity includes determining the local context to determine the boundary of the entity.

21. The apparatus of claim 19, wherein the means for identifying a prominent entity includes determining that the frequency with which a combination of words is searched exceeds a pre-determined threshold.

22. The apparatus of claim 19, wherein the means for identifying a prominent entity includes determining that a frequency with which a first word and a second word are searched exceeds a frequency with which the second word and a third word are searched.

23. The apparatus of claim 19, wherein the means for identifying a prominent entity includes determining evaluating capitalization of words in the page.

24. The apparatus of claim 19, wherein the means for identifying a prominent entity includes determining the existence of an HTML tag in the page.
